(19) United States
(12) Patent Application Publication
(10) Pub. No.: US 2014/0101682 A1
(43) Pub. Date: Apr. 10, 2014

(54) TELEVISION AUTO-TUNE BASED ON HABITUAL VIEWING BEHAVIORS

(71) Applicant: MICROSOFT CORPORATION, Redmond, WA (US)

(72) Inventors: Mark Schlager, San Carlos, WA (US); Darren Sterling, Ottawa (CA)

(73) Assignee: Microsoft Corporation, Redmond, WA (US)

(21) Appl. No.: 13/648,289

(22) Filed: Oct. 10, 2012

(51) Int. Cl. H04N 21/47

(52) U.S. Cl. 725/14

(57) ABSTRACT

An auto-channel device (ACD) corresponds to a television viewing device (TVD) wherein the ACD collects information regarding the channels or programs viewed on the TVD for analysis and processing to determine the specific television programming and/or channel most likely to be watched during particular time periods corresponding to the TVD in order to automatically tune the TVD accordingly. The TVD may be auto-tuned to a specific channel when the TVD first enters an active state based on the analysis results and the time the TVD enters the active state. Likewise, the TVD may also be auto-tuned to a new channel corresponding to the end of first program on a first channel and the commencement of a second program on a second channel again based on the analysis results and current time.

### BACKGROUND

Television (TV) is a telecommunication medium for transmitting and receiving moving images (and the typically accompanying sound) that has become a ubiquitous form of home entertainment, news, and advertising. Televisions sets—also widely referred to simply as a televisions (or TVs)—are electronic home-entertaining devices able to receive and decode television broadcast signals and, thus, used primarily for the display of television audio-visual broadcasts including programs, commercials, announcements, and other television signals. Accordingly, the term “television” (and TV) may refer specifically to a television set, television programming, television transmission, or the whole of the telecommunication medium itself. Over time, television audiences have grown and spurred the creation of more and more broadcasting facilities, resulting in literally hundreds and hundreds of separate program channels and options available to users today.

It is common for viewers to intentionally tune in to particular programs available at particular times on particular days (and perhaps during particular television viewing “seasons” or times of the year) that are made available on a certain specific channel. A television viewer may intentionally tune in to a particular channel by manually entering the channel number directly into the television set. The viewer may also move sequentially from channel to channel using a sequential up-or-down channel selector but not pausing to view intermediate stations. Some TV remote controls may also allow the viewer to select certain channels as “favorites” where only those channels are tuned in when using the sequential channel function (and the non-favorite channels then being accessible only through direct input of the station number).

Similarly, a television viewer may also intentionally tune in to a particular program (on a specific channel at a particular time) to the extent such channel numbers are committed to memory along with the corresponding program and broadcast time. However, it may be challenging for a viewer to recall a specific channel from among the hundreds of channels available corresponding to a particular program at a particular time (presuming, of course, the viewer recalls both the program and its broadcast time in the first place), and failure to recall this information may result in the viewer having to “surf” channels until the particular channel with the particular program at the particular time can be manually located or otherwise find the program/time/channel information using some other means (such as a television broadcast listing or guide). However, even when the channel is known to the viewer, the very need to retune the television set to the particular channel may itself be an inconvenience, particularly when the television set is first turned on and/or a sequence of programs on different channels are frequently viewed consecutively.

### SUMMARY

Various implementations disclosed herein are directed to an auto-channel device (ACD) corresponding to a television viewing device (TVD) wherein the ACD collects information regarding the channels or programs viewed on the TVD (as selected by the various users of the device) for analysis and processing (either locally or remotely) to determine the specific television programming and/or channel most likely to be watched during particular time periods corresponding to the TVD in order to automatically tune the TVD accordingly. For several such implementations, the TVD may be auto-tuned to a specific channel when the TVD first enters an active state (i.e., is powered on or returned from a sleeping state, standby mode, screen-saver display, and so forth) based on the analysis results and the current time (i.e., hour, day of the week, and/or time of year) the TVD enters the active state. For several such implementations, the TVD may also be auto-tuned to a new channel corresponding to the end of first program on a first channel and the commencement of a second program on a second channel again based on the analysis results and the current time (a watch event or WE).

Various implementations are directed to a method for auto-tuning a television viewing device (TVD), the method comprising: monitoring the TVD to determine at least one content identifier for each cyclic period of time during which the TVD is in an active state; analyzing the content identifiers corresponding to each cyclic period of time to determine at least one target content identifier for at least one cyclic period of time corresponding to the content identifier which is most likely to be viewed on the TVD during a future period of time; and automatically tuning the TVD to the target content identifier at the future period of time.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a block diagram representative of an exemplary television viewing system in which various implementations disclosed herein may be utilized;

FIG. 2 is a process flow diagram representative of several implementations disclosed herein for determining consistent viewing habits for a TVD;

FIG. 3 is a process flow diagram representative of several implementations disclosed herein for auto-tuning an ACD upon detection of an active state;

FIG. 4 is a process flow diagram representative of several implementations disclosed herein for auto-tuning an ACD upon determination of a watch event (WE); and

FIG. 5 is a block diagram of an example computing environment that may be used in conjunction with example implementations and aspects.

### DETAILED DESCRIPTION

Most television viewers view broadcast television programming in a habitual manner (particularly during “prime time” hours local to the viewer, generally 7 pm-10 pm CT/MT and 8 pm-11 pm ET/PT) such that, at any given time (hour, day of the week, and/or time of the year) a particular viewer typically watches a specific TV program (at the specific time on the specific channel) with a high degree of consistency. Moreover, most viewers that habitually watch particular television programs tend to do so consistently from a specific television viewing device (TVD) from among what may be several TVDs that are regularly available to that user, and even if that particular TVD is used by several different users at different times. Accordingly, even though many different viewers (such as members of a single family residing together) may watch a variety of programs on any single TVD on different channels at different times, each TVD is typically used by only one viewer (or one set of viewers) at any given time. Consequently, habitual viewing habits may be determined on a TVD-by-TVD basis as an amalgamation of the various viewers who may in fact use the device at different times with different preferences regarding different programs on different channels.

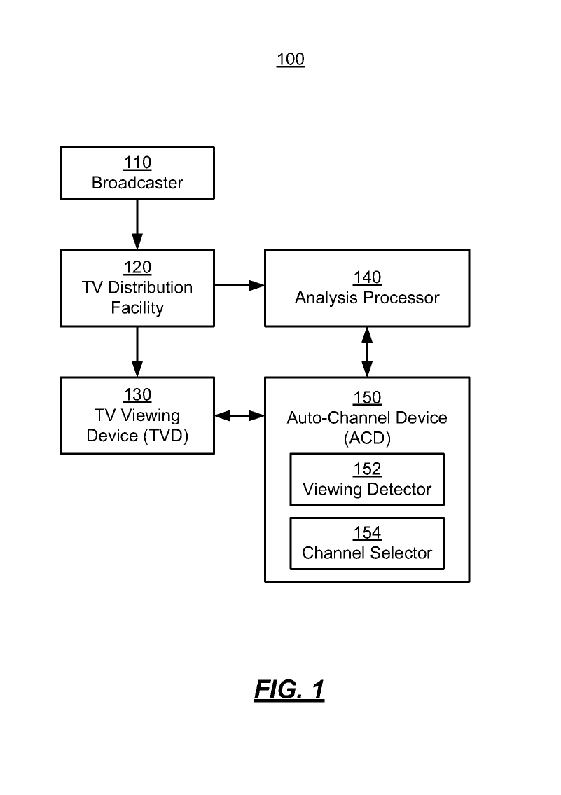

FIG. 1 is a block diagram representative of an exemplary television broadcast system (TBS) 100 in which various implementations disclosed herein may be incorporated. In FIG. 1, a plurality of television broadcasters such as television broadcaster 110 provide programming content to multiple television distribution facilities such as television distribution facility 120. Television distribution facility 120, in turn, provides the programming content received from the plurality of broadcasters to a plurality of TVDs such as TVD 130 over a plurality of channels receivable by the TVDs. TVD 130 receives the programming content, decodes it, and displays it to a user when the channel corresponding to the programming content is selected for display.

For various implementations disclosed herein, the TBS 100 may further comprise an analysis processor 140 and an auto-channel device (ACD) 150. The analysis processor 140 may be communicatively coupled to the television distribution facility 120 and receives from it broadcast information regarding the various programs, channels, and times delivered by the television distribution facility 120 to the TVD 130. The analysis processor 140 is also communicatively coupled to the ACD 150 that, in turn, is operationally coupled to the TVD 130. The ACD 150 further comprises a viewing detector 152 and a channel selector 154. The viewing detector 152 is capable of determining the channel and/or program displayed on the TVD 130 as selected by a user of the TVD 130 and transmitting this information to the analysis processor 140. The channel selector 154, on the other hand, is capable of tuning the TVD 130 to a specific channel automatically or, alternatively, displaying a channel tuning suggestion on the TVD 130 to enable a user of the TVD 130 to manually tune the TVD 130 to the specified channel.

In operation, the viewing detector 152 of the ACD 150 detects over time the specific channels viewed on the TVD at specific times (hour, day of the week, and time of year) and forwards this information to the analysis processor 140 for processing. Upon receipt of sufficient data from the ACD 150 for the specific TVD 130, the analysis processor statistically determines results pertaining to which programs or channels are most likely to be viewed on the TVD 130 at specific times (each a “target” program or channel). These results may be used by the channel selector 154 of the ACD 150 to auto-tune the TVD to the target program or channel when (a) the TVD next enters an active state (i.e., is powered on or returned from a sleeping state, standby mode, screen-saver display, and so forth) and/or (b) auto-tuned to a new channel upon the end of first target on a first channel and the commencement of a second target on a second channel when the TVD 130 is being viewed (a watch event or WE). These processes are described in more detail below.

For various such implementations, and to avoid catching spurious data resulting from channel surfing or other non-indicative viewing on the TVD 130, various filters and thresholds may be utilized such as, for example, using a minimum viewing time (or duration) of a program during monitoring before a data point is recorded, or recording the data point with information pertaining to the viewing time.

For several implementations disclosed herein, the analysis processor 140 may be centralized and/or incorporated into or be part of the television distribution facility 120 or other centralized location providing such services. Likewise, the ACD 150 may be incorporated into or be part of the TVD 130. For several alternative implementations, the analysis processor 140 may be distributed and incorporated into the ACD 150 which, in turn, may be incorporated into the TVD 130.

Furthermore, for certain implementations the consistent viewing habits of specific programs may be tracked (i.e., “program-level tracking”) by the ACD 150 and analyzed by the analysis processor 140 when channel/program/time information is provided by the television distribution facility 120 to at least the analysis processor 140 which can then be mapped up to the channel/time information detected by the viewing detector 152 of the ACD 150. This, in turn, enables a more refined tracking of the viewing usage of the TVD 130 and enables enhanced functionality with regard to the specific programs being consistently viewed on the TVD 130. For example, the auto-tune feature may operate differently in situations where there are scheduling changes to a specific program (such as a regularly scheduled program being delayed to accommodate a living sporting event, for example), when a specific program is a new episode versus a rerun (the latter not prompting an automatic channel change or the like, for example), or when a habitually viewed program is only presented for part of the year such as during the spring, summer, winter, and fall “broadcast seasons” (and thus is auto-tuned only during the corresponding season).

However, if this information is not made available by the television distribution facility 120 to at least the analysis processor 140, for certain alternative implementations the ACD 150 and the analysis processor 140 may still operate to track channel viewing information alone (i.e., “channel-level tracking”) to determine consistent viewing use of the TVD 130 with regard to specific channels without awareness of (or enhanced features pertaining to) the specific programs being delivered over said channels on a daily and/or weekly (i.e., day-of-the-week) basis, as well as possibly on a monthly, quarterly, or annual basis (with enough data collection over time) to implement some limited implementations of certain enhanced features described above for “program-level tracking” implementations.

With regard to the foregoing general description, the following provides some exemplary implementations illustrative of the more general applications of said implementations and pertaining to certain specific implementations disclosed herein.

FIG. 2 is a process flow diagram 200 representative of several implementations disclosed herein for determining consistent viewing habits for a TVD 130. At 210, the viewing detector 152 of the ACD 150 monitors the TVD 130 (e.g., monitors the TVD 130 at regular intervals during times the TVD 130 is being used) to determine which channels are being viewed at which times (i.e., hour, day of the week, and/or time of the year). At 220, the results of this monitoring are reported to the analysis processor before looping back for continued monitoring at 210.

At 230, a determination is made by the analysis processor 140 as to whether sufficient data (together with any previously received but unprocessed data) has been received to statistically determine an identifiable pattern of consistent viewing (program-level or channel-level) taking place on the TVD 130—or, alternately, if there is sufficient data (again, program-level or channel-level) to update a previous identified pattern of consistent channel viewing occurring on the TVD 130. If not, at 240 the received data is stored for future processing and the analysis processor awaits receipt of additional information from the viewing detector 152 of the ACD 150 (indicated by the return to 220).

On the other hand, if there is sufficient data (together with any previously received but unprocessed data) to statistically determine an identifiable pattern of consistent viewing taking place on the TVD 13—or, alternatively, update a previous determination with the newly received data—the data is analyzed at 250 and the results (comprising channels or programs that are likely to be viewed by the TVD 130 at specific times) are made available to the ACD 150 at 260 before the process returns to again await receipt of additional data from the viewing detector 152 of the ACD 150 for subsequent updates (indicated by the return to 220).

With regard to updating, it should be noted that for various such implementations the monitoring is recursive (occurs repeatedly), and thus the targets are reevaluated and updated based on past information plus additional information subsequently collected during subsequent monitoring. In this way, targets are kept current and greater accuracy may be achieved, especially in models where more recent data is weighed more heavily than less recent data.

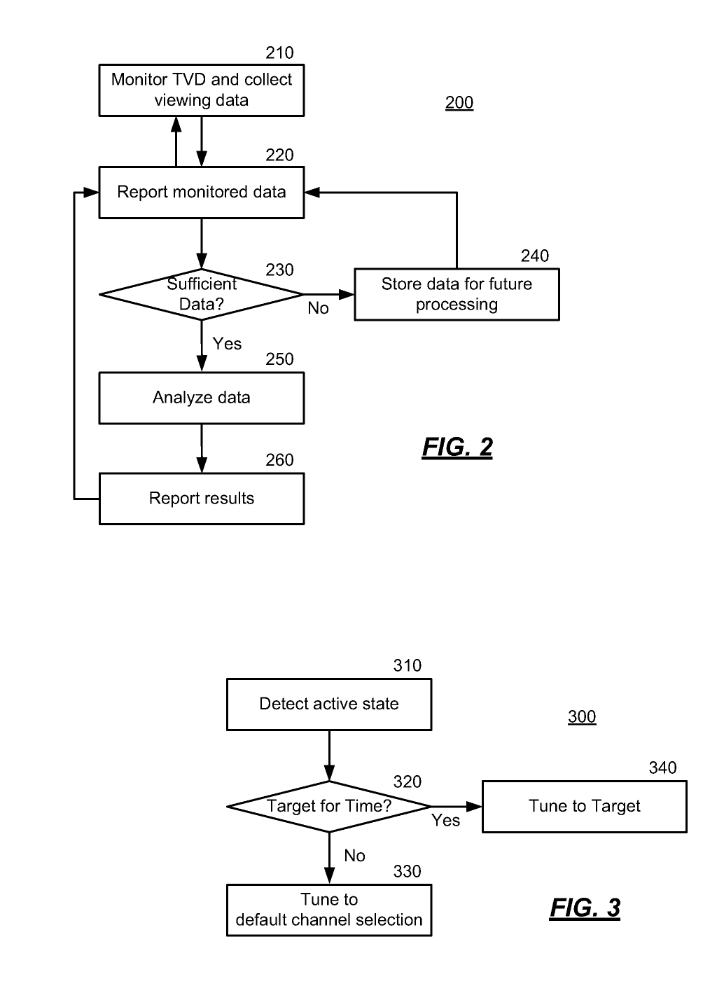

FIG. 3 is a process flow diagram 300 representative of several implementations disclosed herein for auto-tuning an ACD 150 upon detection of an active state. At 310 the ACD, via the viewing detector 152 or other means, detects that the TVD 130 has entered an active state (i.e., has been powered on or returned from a sleeping state, standby mode, screen-saver display, or the like) and determines, at 320, whether there is a target (i.e., a program or channel that is most likely to be viewed on the TVD 130 at specific times) for the current time (hour, day of the week, and/or time of year accordingly).

If so, at 340 the ACD 150 uses the channel selector 154 to tune the TVD 130 to the corresponding target channel. Conversely, if a target does not exist for the current time, then the ACD 150 instead uses the channel selector 154 to tune the TVD 130 to a default channel. For specific implementations, the default channel may be one of the lowest channel number available, the last channel viewed on the TVD at the end of the previous active state, the most commonly viewed channel, a default channel previously identified by the user, the channel corresponding to the closest target to the current time, or a default channel determined by some other means. Likewise, for certain implementations the default channel may be one of the foregoing as selected by a user.

FIG. 4 is a flow diagram of a process 400 representative of several implementations disclosed herein for auto-tuning TVD 130 upon determination of a watch event (WE). In FIG. 4, at 410 the ACD 150 monitors use of the TVD 130 to determine the end of a first target on a first channel and the commencement of a second target on a second channel (constituting a watch event or WE). At 420, the ACD 150 notifies the user of the TVD 130 of the pending WE. At 430, the ACD 150 (via the channel selector 154) facilitates a transition (changes the channel) from the first channel to the second channel on the TVD 130 before returning to monitor for the next WE at 410 again.

Accordingly, with regard to FIGS. 2, 3, and 4 combined, the processes therein together describe a method for auto-tuning a television viewing device (TVD) comprising: (1) monitoring the TVD to determine at least one content identifier (a channel or a program, that is, wherein the content identifier corresponds to either (a) a channel without identifying the corresponding program viewed on the TVD, or (b) a program on that channel being viewed on the TVD at that time, such that the content identifier corresponds to a program identified using information received from a television distribution facility and corresponding to a channel viewed on the TVD) for each cyclic period of time (a repeating period, e.g., a specific time of day, a specific time and day of the week, a specific time and day of a television broadcasting season, and/or a specific time and day of the year) during which the TVD is in an active state; (2) analyzing the content identifiers corresponding to each cyclic period of time to determine at least one target content identifier for at least one cyclic period of time corresponding to the content identifier which is most likely to be viewed on the TVD during a future period of time (i.e., the most likely to be viewed channel or program at a corresponding future time); and (3) automatically tuning the TVD to the target content identifier at the future period of time (which may correspond to either to an activation event or a watch event, for example).

For certain implementations, the monitoring at 410 may be conducted using predefined time boundaries corresponding to typical broadcast program transitions (i.e., the end of one program and the beginning of another). For example, the monitoring may operate to detect whether one or more WEs occur at fifteen minute increments (e.g., at the top of each hour and at :15, :30, and :45 minutes past each hour), each of which constitutes a time boundary. Thus, when a WE is set to occur at an upcoming time boundary, the process proceeds from 410 to the user notification of 420.

For certain implementations, the notification the user receives at 420 may be merely a indication that a channel change is imminent (and automatically occurs at 430) and, for some implementations, the user may be able to cancel this imminent channel change if the channel change is undesired and the process immediately returns to monitoring (from 420 to 410 as indicated by the dotted-line-arrow) without facilitating any transition at 430. For certain other implementations, the notification the user receives at 420 may require the user to confirm or accept the indicated channel change before the process proceeds to change the channel (facilitate transition) at 430, and if the confirmation or approval is either declined (actively) or not indicated (passively), then the process immediately returns to monitoring (from 420 to 410 as indicated by the dotted-line-arrow).

For certain alternative implementations of the foregoing process 400, there may be no notification element 420 such that, upon occurrence of a WE at a time boundary, the ACD 150 (via the channel selector 154) facilitates a transition (changes the channel) from the first channel to the second channel on the TVD 130 and then returns to monitor for the next WE at 410 again.

For select implementations, an “overlapping” WE may also be determined when a first and second target overlap such that the second target commences (on a different channel) before a first target completes. For such implementations, the ACD 150 may notify the user of the TVD 130 of the upcoming start of the second target and provide the user the option to have the ACD 150 (using the channel selector 154) to facilitate a transition 430 from the first target (channel) to the second target (channel) upon occurrence of the time corresponding to this special “overlapping” WE.

In addition, for any of the various implementations herein disclosed, the user may also be provided an option to record the first target, the second target, and/or both instead of or in addition to selecting which target to watch at the time boundary.

It should be noted that for periods of time that occur between each time boundary (each a time block), targets may be determined for each time block accordingly with regard to the monitored and analyzed data of FIG. 2, and a list of programs viewed during each time block and associated weighted based on the viewing that is monitored could be used to determine the target for said time block. Accordingly, when the target of any time block is a program that continues into a subsequent time block for which the program is not the target, an overlapping WE may be determined. In any event, maintaining a list of target and non-target candidates enables certain implementations to promote and demote entries for each time block as new data is obtained and processed such that the target may change over time among several candidates.

Likewise, while basis analysis for targets based on weekday and time is suitable for certain implementations, other implementations may also attempt to capture, process, and utilize target information based on television broadcast season and/or annual television view habits to capture viewing patterns that extend beyond a mere week-to-week analysis. Moreover, while such a long-term approach may be utilized for both “channel-level” and “program-level” assessments, specific implementations for the latter may be further supplemented to utilize additional information provided by the television distribution facility 120 to implement a deeper program-level analysis.

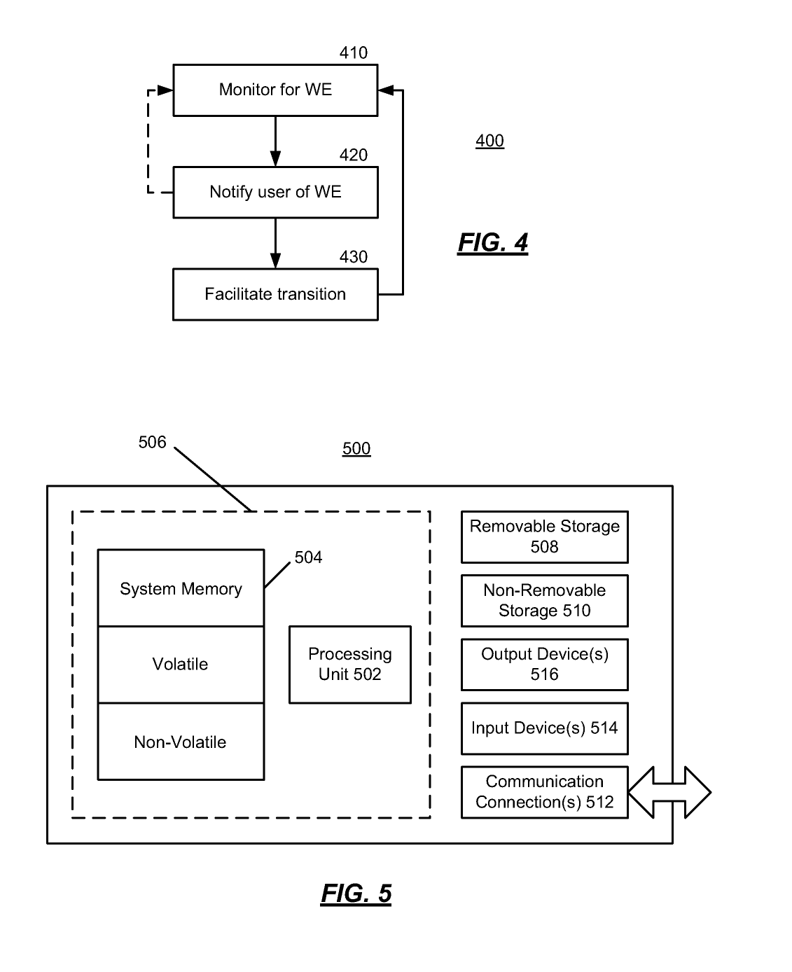

As used herein, a TVD may comprise (but is not limited to) a smart TV, a set-top box, or other device used to display live, on-demand, pay-per-view, or any other programming available to a user of the TVD. Likewise, a TVD may comprise a general purpose or special purpose computing system (an example of which is described with respect to FIG. 5) implemented in software and/or hardware and including those capable with interfacing with broadcasters providing television broadcasts over any medium including but not limited to the Internet.

Moreover, as described herein, viewing behavior is tracked on a device level where each device can be uniquely identified and tracked by the system. However, for scenarios where multiple devices (such as those in a single household) might only be able to be tracked collectively, and thus various alternative implementations disclosed herein may track a larger entity comprising more than one device in a manner similar to a single device. Conversely, for other instances where individual users may be identified for a single device or across a plurality of devices, various alternative implementations may instead be similarly implemented on a user level to provide even more specific and customized determinations accordingly. Moreover, users may have multiple logins or profiles, individual or shared accordingly, that may also be tracked by certain other alternative implementations. Thus nothing herein is intended to limit the disclosures herein to any specific level of abstraction (user, device, group, account, profile, etc.) but the implementations disclosed herein are merely representative of all of these alternative implementations that are likewise anticipated by this disclosure and included herewith accordingly.

FIG. 5 is a block diagram of an example computing environment that may be used in conjunction with example implementations and aspects. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well-known in the art and need not be discussed at length here.

Computing device 500 may be one of a plurality of computing devices 500 inter-connected by a network. As may be appreciated, the network may be any appropriate network, each computing device 500 may be connected thereto by way of communication connection(s) 512 in any appropriate manner, and each computing device 500 may communicate with one or more of the other computing devices 500 in the network in any appropriate manner. For example, the network may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for auto-tuning a television viewing device (TVD), the method comprising:
monitoring, by a viewing detector of an auto-channel device, the TVD over a first period of time, to collect viewing data when the TVD is in an active state;
analyzing, by an analysis processor that is coupled to the auto-channel device, the viewing data to statistically determine a pattern of consistent viewing comprising at least one of a habitually viewed channel or a habitually viewed program on the TVD; and
automatically tuning by the auto-channel device, on the basis of the analysis results automatically provided by the analysis processor to the auto-channel device, the TVD to the at least one of a habitually viewed channel or a habitually viewed program at a second period of time when the TVD is powered on for viewing.

2. (canceled)

3. The method of claim 1, wherein the at least one of a habitually viewed channel or a habitually viewed program is identifiable by a content identifier.

4. The method of claim 3, wherein the content identifier corresponds to a program that is identified using information received from a television distribution facility.

5. The method of claim 1, wherein the first period of time comprises at least one of a day, a week, a broadcast season, or a year.

6. The method of claim 1, further comprising automatically tuning the TVD, upon the occurrence of an activation event, to a target content identifier of a cyclic period of time corresponding to a current time of the activation event.

7. The method of claim 3, further comprising automatically retuning the TVD, upon the occurrence of a watch event subsequent to the second period of time, from a target content identifier to another content identifier, wherein the another content identifier corresponds to a third time period subsequent to the second period of time.

8. (canceled)

9. The method of claim 1, wherein determining the pattern of consistent viewing is based, at least in part, on a minimum threshold corresponding to a minimum duration of viewing of the at least one of a habitually viewed channel or a habitually viewed program by a viewer.

10. (canceled)

11. The method of claim 1, wherein the monitoring is recursive, and the pattern of consistent viewing is reevaluated and updated based on additional information collected during a subsequent monitoring.

12. The method of claim 1, wherein the first period of time is cyclic.

13. A system for auto-tuning a television viewing device (TVD), the system comprising:
a viewing detector for detecting at least one content identifier for each cyclic period of time during which the TVD is in an active state;
an analysis processor for analyzing the content identifiers corresponding to each cyclic period of time to determine at least one target content identifier that is consistently used on the TVD; and
a channel selector that automatically tunes the TVD to the target content identifier at a future period of time based upon an analysis result automatically provided to the channel selector by the analysis processor.

14. The device of claim 13, wherein the viewing detector and the channel selector comprise an auto-channel device that is coupled to the TVD or is a component part of the TVD.

15. The device of claim 13, wherein the analysis processor is centrally located, communicatively coupled to a television distribution facility, and provides processing services to a plurality of auto-channel devices each coupled to each of a plurality of TVDs.

16. The device of claim 15, wherein the content identifiers correspond to programs, and the analysis processor receives program information from the television distribution facility.

17. The device of claim 13, wherein the analysis processor is a component of an auto-channel device.

18. The device of claim 17, wherein the content identifiers correspond to channels viewable on the TVD as determined by the viewing detector.

19. A computer-readable storage medium that is not a signal, the computer-readable storage medium comprising computer-readable instructions for auto-tuning a television viewing device (TVD), the computer-readable instructions comprising instructions that cause a processor to:
monitor the TVD over a first period of time to collect viewing data when the TVD is in an active state;
analyze the viewing data to determine at least one target content identifier that is consistently accessed on the TVD; and
using the determination to automatically tune the TVD to the at least one target content identifier at a future period of time.

20. The computer-readable storage medium of claim 19, further comprising instructions for causing the processor to:
automatically tune the TVD at an activation event; and
automatically retune the TVD at a watch event.

21. The method of claim 1, wherein the pattern of consistent viewing comprises a TVD-by-TVD amalgamation of viewing habits of a plurality of viewers.

22. The method of claim 1, wherein the viewing data used to statistically determine the at least one of a habitually viewed channel or a habitually viewed program comprises viewing data obtained by monitoring a plurality of viewers having one or more of different preferences, different viewing times, different programs, or different channels.

23. The system of claim 13, wherein the each cyclic period of time during which the TVD is in an active state corresponds to a pattern of consistent viewing by a plurality of viewers of the TVD.
